(19) United States
(12) Patent Application Publication
(10) Pub. No.: US 2010/0183939 A1
(43) Pub. Date: Jul. 22, 2010

(54) FUEL CELL SYSTEM

(75) Inventors: Hiroyuki Sekine, Nagoya-shi (JP); Norio Yamagishi, Nishikamo-gun (JP); Kazuyuki Oikawa, Shioya-gun (JP); Koji Katano, Toyota-shi (JP); Yasunobu Jufuku, Mishima-shi (JP); Hidehiko Koyata, Fujimi-shi (JP)

Correspondence Address: KENYON & KENYON LLP, 1500 K STREET N.W., SUITE 700, WASHINGTON, DC, 20005, US

(73) Assignee: TOYOTA JIDOSHA KABUSHIKI KAISHA, Toyota-shi (JP)

(21) Appl. No.: 12/440,164

(22) PCT Filed: Sep. 5, 2007
(86) PCT No.: PCT/JP2007/067687

§ 371 Date: Mar. 5, 2009

(30) Foreign Application Priority Data
Sep. 6, 2006 (JP) 2006-242015

(51) Int. Cl. H01M 8/24

(52) U.S. Cl. 429/457

(57) ABSTRACT

A fuel cell system including a fuel cell stack having stacked cells for generating electricity by an electrochemical reaction between a fuel gas and an oxidizing gas and held between a pair of end plates arranged at both ends in the stacking direction of the cells, and also including a gas-liquid separator for separating a gas and a liquid of an off-gas discharged from the fuel cell stack, wherein the gas-liquid separator is fixed to the end plate. Exhaust heat of the fuel cell stack is effectively used to heat the gas-liquid separator.

### TECHNICAL FIELD

The present invention relates to a fuel cell system comprising a fuel cell stack which is supplied with reaction gases and thus generates electricity by an electrochemical reaction therebetween.

### BACKGROUND ART

Recently, attention has been focused on a fuel cell system using, as an energy source, a fuel cell which generates electricity by an electrochemical reaction between a fuel gas and an oxidizing gas. The fuel cell used for this fuel cell system is configured, for example, by fixing a fuel cell stack of a plurality of single cells to an end plate.

An exhaust pipe through which an off-gas to be discharged runs is connected the fuel cell. This exhaust pipe is provided with a gas-liquid separator for separating a gas and a liquid in the off-gas running in this exhaust pipe (e.g., refer to Japanese Patent Publication Laid-open No. 2005-332676).

### DISCLOSURE OF INVENTION

In the meantime, water inside a gas-liquid separator may be frozen at low outdoor air temperature, and this can reduce the rate of gas-liquid separation. Moreover, when water in the gas-liquid separator is frozen, a pump, if provided downstream, can wrongly operate.

It is therefore an object of the present invention to provide a fuel cell system capable of inhibiting the freeze of water inside a gas-liquid separator.

In order to achieve the foregoing object, according to the present invention, there is provided a fuel cell system comprising: a fuel cell stack having a plurality of stacked cells which generate electricity by an electrochemical reaction between a fuel gas and an oxidizing gas, and held between a pair of end plates arranged at both ends in the stacking direction of the cells; and a gas-liquid separator which separates a gas and a liquid of an off-gas discharged from the fuel cell stack, wherein the gas-liquid separator is fixed to the end plate.

According to this configuration, exhaust heat of the fuel cell stack is transmitted to the gas-liquid separator via the end plates, so that the exhaust heat is effectively used to satisfactorily heat the gas-liquid separator.

The gas-liquid separator may include a ribbon section which forms the introduced off-gas into a swirl flow to separate liquid drops therefrom, and the ribbon section may be disposed adjacently to the end plate.

According to this configuration, the distance between the fuel cell stack and the ribbon section can be reduced. This enables the off-gas discharged from the fuel cell stack to be formed into the swirl flow while being at a high flow velocity, so that separation efficiency improves. Moreover, the end plates and the ribbon section are adjacently disposed. Thus, if any member is provided therebetween, an increase in the thermal capacity of this member can be inhibited, and heating efficiency can be improved.

When a circulating pump which returns the off-gas to the fuel cell stack is connected to a gas outlet of the gas-liquid separator via a pipe, this pipe may be provided with a foldback portion which folds back at an angle of more than 90 degrees.

According to this configuration, when water which has not been separated in the gas-liquid separator is sent to the circulating pump from the gas outlet via the pipe, further gas-liquid separation is achieved by the foldback portion of the pipe folding back at an angle of more than 90 degrees. This can inhibit the water which has not been separated in the gas-liquid separator from flowing into the circulating pump.

Furthermore, the gas-liquid separator may be horizontally provided with a water outlet, and a bottom of the gas-liquid separator may be forwardly downwardly inclined toward the water outlet.

A downward recess may be formed in the bottom to extend along the inclination direction of the bottom, and the water outlet may be provided to extend from the recess.

The inclination angle of side bottoms other than the recess in the bottom may be greater than the inclination angle of the recess.

According to the present invention, the gas-liquid separator is fixed to the end plate, so that the exhaust heat of the fuel cell stack can be effectively used to satisfactorily heat the gas-liquid separator. Thus, water inside the gas-liquid separator can be inhibited from freezing.

### BRIEF DESCRIPTION OF DRAWINGS

FIG. 1 is a configuration diagram showing a first embodiment of a fuel cell system according to the present invention;

FIG. 2 is a plan view of a stack case and its inside in the first embodiment of the fuel cell system according to the present invention;

FIG. 3A is a plan view showing, while omitting a circulating pump, etc., essential parts in the first embodiment of the fuel cell system according to the present invention, and FIG. 3B is a front view thereof;

FIG. 4 is a sectional side view showing a ribbon section in the first embodiment of the fuel cell system according to the present invention;

FIG. 5 is a view from the side of a flange portion showing the ribbon section in the first embodiment of the fuel cell system according to the present invention;

FIG. 6 is a perspective view showing a gas-liquid separator in a second embodiment of a fuel cell system according to the present invention; and

FIG. 7A is a side view showing the gas-liquid separator in the second embodiment of the fuel cell system according to the present invention, and FIG. 7B is a front view thereof.

### BEST MODE FOR CARRYING OUT THE INVENTION

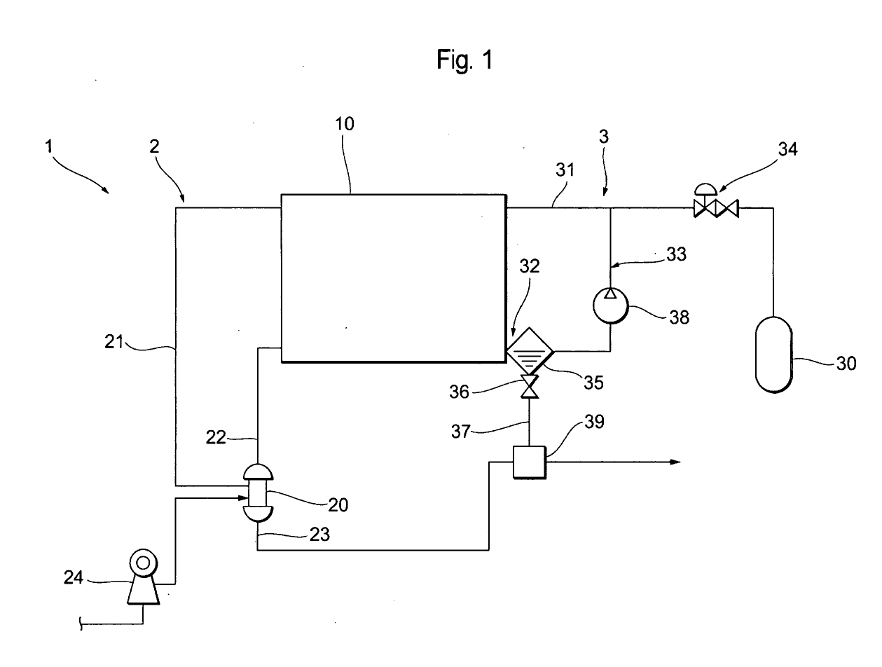

Now, a first embodiment of a fuel cell system according to the present invention will be described with reference to FIG. 1 to FIG. 5.

FIG. 1 is a diagram of the configuration of a fuel cell system 1. This fuel cell system 1 is applicable to an in-vehicle power generation system of a fuel-cell automobile, to power generation systems for various mobile objects such as a ship, an airplane, a train or a walking robot, and to, for example, a stationary power generation system used as power generation equipment for a structure (such as a house or a building). However, the fuel cell system 1 is intended for automobiles in particular.

The fuel cell system 1 comprises a fuel cell 10 which is supplied with reaction gases (an oxidizing gas and a fuel gas) and thus generates electricity by an electrochemical reaction therebetween. The fuel cell system 1 also comprises a cathodic oxidizing gas piping system 2 for adjusting the supply of, for example, air as the oxidizing gas to the fuel cell 10, and an anodic fuel gas piping system 3 for adjusting the supply of, for example, a hydrogen gas as the fuel gas.

The oxidizing gas piping system 2 includes: an air supply pipe 21 for supplying the fuel cell 10 with the oxidizing gas (air) humidified by a humidifier 20; an exhaust pipe 22 for guiding an oxidized off-gas discharged from the fuel cell 10 to the humidifier 20; and a discharge pipe 23 for guiding the oxidized off-gas to the outside from the humidifier 20. The air supply pipe 21 is provided with a compressor 24 for taking in the oxidizing gas in the atmosphere and feeding the oxidizing gas to the humidifier 20 by pressure.

The anodic fuel gas piping system 3 includes: a hydrogen tank 30 as a fuel supply source retaining a high-pressure hydrogen gas; a fuel supply pipe 31 for supplying the fuel cell 10 with the hydrogen gas in the hydrogen tank 30; an exhaust pipe 32 through which a hydrogen off-gas as an off-gas of the fuel gas discharged from the fuel cell 10 flows; and a circulating pipe 33 for returning the hydrogen off-gas in the exhaust pipe 32 to the fuel supply pipe 31.

In order to supply the fuel gas to the fuel cell 10, the fuel supply pipe 31 is provided with a shut-valve-equipped regulator 34 for shutting or permitting the supply of the hydrogen gas from the hydrogen tank 30 and for adjusting the pressure of the hydrogen gas when permitting the supply. Instead of this shut-valve-equipped regulator 34, an injector may be provided to adjust the conditions (such as flow volume, pressure, temperature and mol concentration) of the gas on the upstream side and then supply the gas to the downstream side.

The exhaust pipe 32 is provided with a gas-liquid separator 35 for resupplying the hydrogen off-gas discharged from the fuel cell 10 to the fuel cell 10 via the circulating pipe 33. The gas-liquid separator 35 separates a gas and a liquid in the hydrogen off-gas discharged from the fuel cell 10, and more specifically, collects water from the hydrogen off-gas. An air/water discharge valve 36 is connected to the gas-liquid separator 35, and a discharge pipe 37 is connected to this air/water discharge valve 36.

The air/water discharge valve 36 operates in accordance with an instruction from an unshown controller to discharge (purge) the water collected in the gas-liquid separator 35 and the hydrogen off-gas containing impurities in the exhaust pipe 32 to the outside via the discharge pipe 37.

The circulating pipe 33 is provided with a circulating pump 38. The circulating pump 38 sucks in and pressurizes the hydrogen off-gas in the circulating pipe 33 discharged from the fuel cell 10 and then lets out the hydrogen off-gas toward the fuel supply pipe 31, thereby adjusting the circulation of the gas discharged from the fuel cell 10. Moreover, the discharge pipe 37 is provided with a diluter 39 for diluting the hydrogen off-gas with an oxygen off-gas from the discharge pipe 23.

In the first embodiment of such a fuel cell system 1, electricity is generated by an electrochemical reaction caused in the fuel cell 10 between the hydrogen gas adjusted by the shut-valve-equipped regulator 34 and supplied to the fuel cell 10 from the hydrogen tank 30 via the fuel supply pipe 31 and the oxygen gas humidified by the humidifier 20 and introduced into the fuel cell 10 via the air supply pipe 21 due to the pressure feed by the compressor 24.

Furthermore, the hydrogen off-gas from the fuel cell 10 is introduced into the gas-liquid separator 35 of the exhaust pipe 32, introduced into the fuel supply pipe 31 via the circulating pipe 33 by the circulating pump 38, and again introduced into the fuel cell 10. Then, when the air/water discharge valve 36 is opened with proper timing, the hydrogen off-gas from the fuel cell 10 is introduced into the diluter 39 from the gas-liquid separator 35 via the discharge pipe 37, and diluted in this diluter 39 with the oxygen off-gas discharged from the fuel cell 10, and then discharged to the outside.

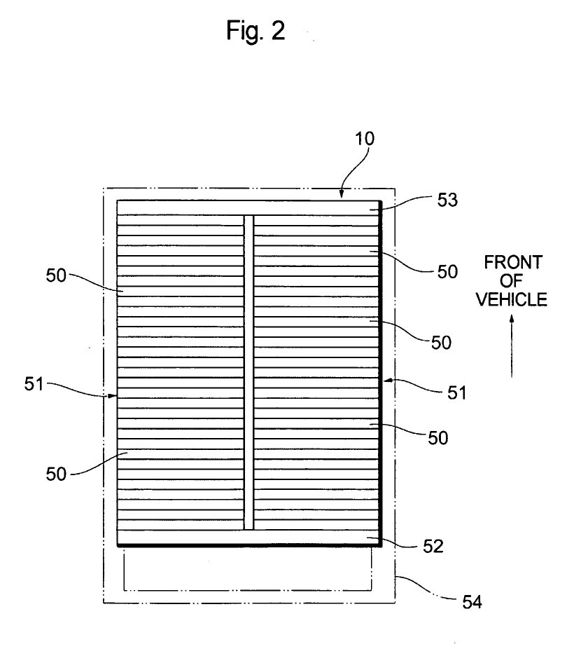

As shown in FIG. 2, the fuel cell 10 has: a plurality of (two) fuel cell stacks 51, 51 each composed of a required number of single cells 50 which are supplied with the reaction gases and thus generate electricity by an electrochemical reaction therebetween; a pair of end plates 52, 53 which arrange the fuel cell stacks 51, 51 in parallel with the single cells 50 and hold the fuel cell stacks 51, 51 from both ends in the stacking direction; and an unshown tension plate which couples the end plates 52, 53 together. The fuel cell 10 is housed in a stack case 54.

The fuel cell 10, housed in the stack case 54 as described above, is installed on the body of a vehicle in such a posture as to keep the stacking direction of the single cells 50 horizontal and to keep the parallel arrangement direction of the fuel cell stacks 51, 51 horizontal. At this point, an unshown traction motor is located under the stack case 54, so that the height of the stack case 54 is restricted by this traction motor due to limitations of space. The following explanation is based on the posture during the installation on the vehicle body.

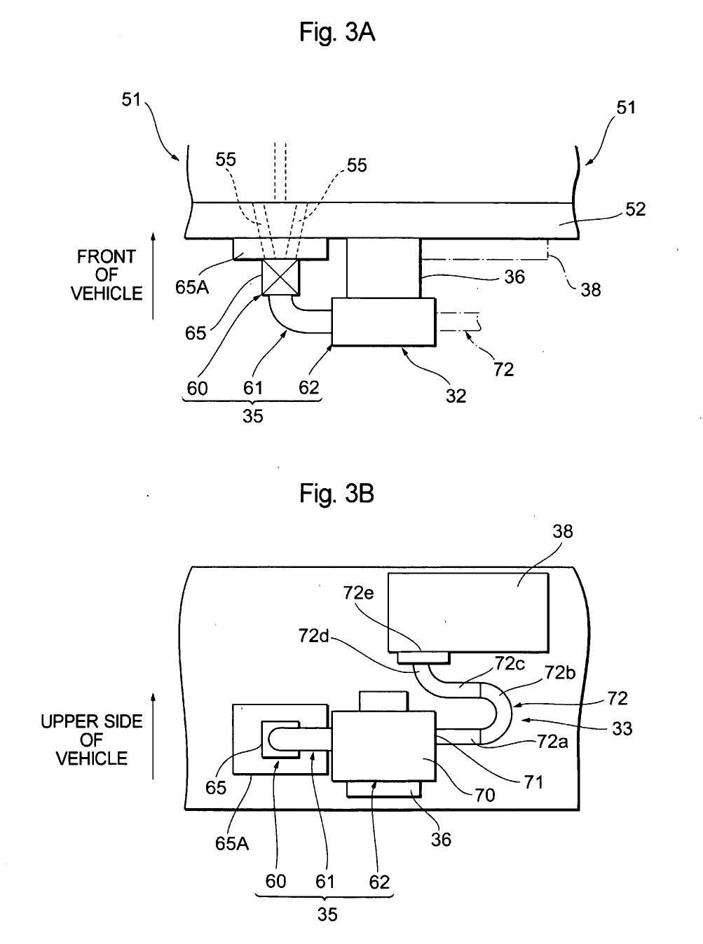

As shown in FIGS. 3A and 3B, discharge flow paths 55, 55 for the hydrogen off-gas discharged from the fuel cell stacks 51, 51 are formed through the end plate 52 of the fuel cell 10 on a vehicle rear side. The exhaust pipe 32 is connected to the discharge flow paths 55, 55. In the first embodiment, the gas-liquid separator 35 of this exhaust pipe 32 is fixed to the end plate 52.

The gas-liquid separator 35 includes: a ribbon section 60 fixed in the immediate vicinity of the end plate 52; a pipe 61 of a pipe member having one end connected to the side of the end plate 52 opposite to the ribbon section 60 and having the other end bent to extend along the planar direction of the end plate 52; and a separation section 62 connected to the other end of the pipe 61.

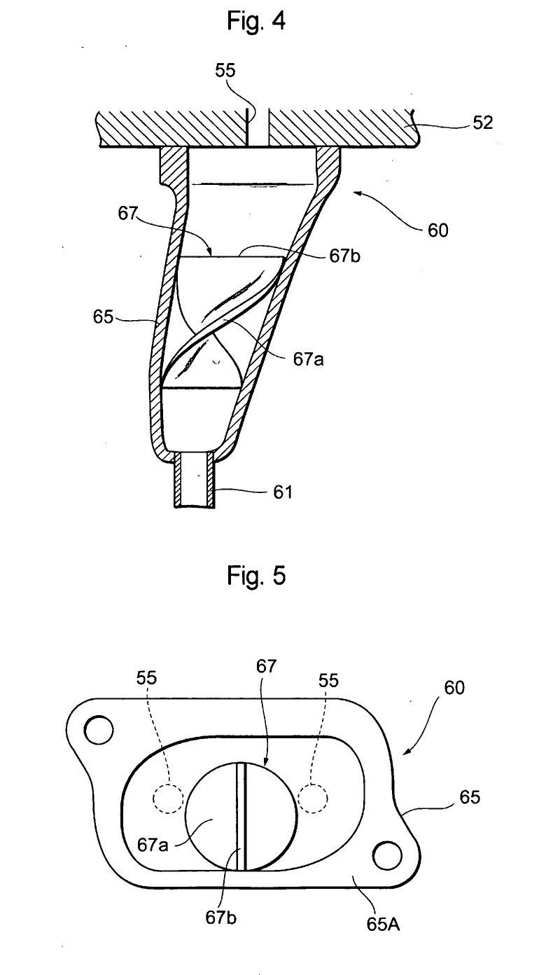

The ribbon section 60 is a cyclone type which produces swirl force in the introduced gas to separate water drops in the gas. As shown in FIGS. 4 and 5, the ribbon section 60 has a housing 65 formed into a bottomed cylindrical shape. This housing 65 has open one end (upstream end), and a flange portion 65A fixable to the end plate 52 is formed in this open part.

Furthermore, this flange portion 65A is fastened and fixed with, for example, bolts via an unshown sealing material, such that the ribbon section 60 is airtightly fixed to the end plate 52. When fixed to the end plate 52 in this manner, the inside of the housing 65 of the ribbon section 60 is in communication with the discharge flow paths 55, 55.

The housing 65 is tapered toward the other end (downstream end), and a ribbon plate 67 is fixed to the inside of the housing 65. This ribbon plate 67 has a swirl plate portion 67a spirally wound along the axial direction, and both side portions of this swirl plate portion 67a are fixed to the inner peripheral surface of the housing 65.

One end portion (upstream end portion) of the ribbon plate 67 serves as a separation plate portion 67b of a flat plate. This separation plate portion 67b is disposed substantially midway between the discharge flow paths 55, 55 formed in the end plate 52 in such a manner as to symmetrically divide the housing 65 in a plan view (see FIG. 5).

Here, the hydrogen off-gas sent into the ribbon section 60 from the discharge flow paths 55, 55 is distributed to swirl flow paths formed by the spirally wound swirl plate portion 67a of the ribbon plate 67 owing to the separation plate portion 67b of the ribbon plate 67. Thus, the distribution of the hydrogen off-gas is uniformed, and the hydrogen off-gas accelerated in a direction traversing the ribbon plate 67 is smoothly guided to the downstream side.

Furthermore, the hydrogen off-gas flown into the swirl flow path is formed into a swirl flow, and introduced into the separation section 62 through the pipe 61 while guiding water in the gas to the outside by its centrifugal force.

As shown in FIGS. 3A and 3B, the separation section 62 has a box-shaped case 70, and the other end of the pipe 61 is connected to the side surface of the case 70. Thus, of the hydrogen off-gas introduced into the case 70 via the pipe 61 in the state of the swirl flow, water guided to the outer side by the centrifugal force is formed into water drops on the inner surface of the case 70. The water drops flows downward, and then retained at the bottom of the case 70.

A pipe 72 is connected to a gas outlet 71 in the side surface of the case 70 of the separation section 62 opposite to the pipe 61, and the pipe 72 configures the circulating pipe 33 into which the hydrogen off-gas separated from the water is sent. Moreover, the air/water discharge valve 36 is provided between the separation section 62 and the end plate 52. The air/water discharge valve 36 discharges the water retained at the bottom of the housing 65, and also discharges the hydrogen off-gas.

The pipe 72 is formed of a pipe member. The pipe 72 has: a linear portion 72a horizontally extending from the side surface of the housing 65 along the planar direction of the end plate 52; a bending portion (foldback portion) 72b bending upward 180 degrees in an arc-shape from the tip of the linear portion 72a along the planar direction of the end plate 52; a linear portion 72c horizontally extending from the tip of the bending portion 72b along the planar direction of the end plate 52 in a direction to approach the housing 65; and a bending portion 72d bending upward from the tip of the linear portion 72c along the planar direction of the end plate 52.

Then, the circulating pump 38 for returning the hydrogen off-gas to the fuel cell stacks 51, 51 is connected, at its low portion, to a flange portion 72e formed at the upper end of the bending portion 72d.

Here, the bending portion 72b has the shape of a 180-degree semicircle, and folds back the pipe 72 at a central angle of 180 degrees exceeding a central angle of 90 degrees.

In addition, the main component of the housing 65 of the ribbon section 60 is formed by press-molding a thin plate, and the ribbon plate 67 is also formed by press-molding a thin plate. Moreover, the main component of the case 70 of the separation section 62 is also formed by press-molding a thin plate.

According to the first embodiment of the fuel cell system 1 described above, the gas-liquid separator 35 for separating the gas and liquid in the off-gas discharged from the fuel cell stacks 51, 51 is fixed to the end plate 52, so that exhaust heat of the fuel cell stacks 51, 51 is transmitted to the gas-liquid separator 35 via the end plate 52 and is thus effectively used to satisfactorily heat the gas-liquid separator 35. Consequently, water inside the gas-liquid separator 35 can be inhibited from freezing.

Furthermore, the ribbon section 60 of the gas-liquid separator 35 is disposed adjacently to the end plate 52. Thus, the distance between the fuel cell stacks 51, 51 and the ribbon section 60 can be reduced, and the hydrogen off-gas discharged from the fuel cell stacks 51, 51 can be formed into a swirl flow while being at a high flow velocity, so that separation efficiency improves.

In addition, the end plate 52 and the ribbon section 60 are adjacently disposed. Thus, if any member is provided therebetween, an increase in the thermal capacity of this member can be inhibited, and heating efficiency can be improved. This enables immediate warm-up.

Moreover, the ribbon section 60 and the separation section 62 of the gas-liquid separator 35 are independent of each other, and are connected via the pipe 61. This assures the flowing distance for the swirl flow of the hydrogen off-gas generated in the ribbon section 60. As a result, the gas and liquid can be satisfactorily separated from each other.

Furthermore, the pipe 72 connecting the gas outlet 71 of the gas-liquid separator 35 to the circulating pump 38 is provided with the bending portion 72b which folds back at an angle of 180 degrees exceeding an angle of 90 degrees. Thus, when the off-gas containing water which has not been separated in the gas-liquid separator 35 is sent to the circulating pump 38 from the gas outlet 71 via the pipe 72, further gas-liquid separation is achieved by the bending portion 72b.

This can inhibit the water which has not been separated in the gas-liquid separator 35 from flowing into the circulating pump 38. Here, water drops separated in the bending portion 72b are returned to the separation section 62 of the gas-liquid separator 35 due to for example, the inclination of a vehicle. In addition, if folded back at an angle of more than 90 degrees, the pipe 72 can sufficiently separate the gas and liquid without being folded back 180 degrees.

Furthermore, the pipe 72 connecting the gas outlet 71 of the gas-liquid separator 35 to the circulating pump 38 has no portion forwardly downwardly inclined from the upstream to downstream. Therefore, water drops separated along the pipe 72 can be satisfactorily returned to the separation section 62 of the gas-liquid separator 35.

Still further, the pipe 72 from the gas-liquid separator 35 is connected to the circulating pump 38 from below. This can further inhibit water from coming into the circulating pump 38.

Further yet, the ribbon section 60 and the separation section 62 of the gas-liquid separator 35 are mainly constituted of thin plates to be press-molded, and are coupled together by the pipe 61 formed of the pipe member. Thus, thermal capacity can be reduced, and in this respect, the gas-liquid separator 35 can be immediately warmed up.

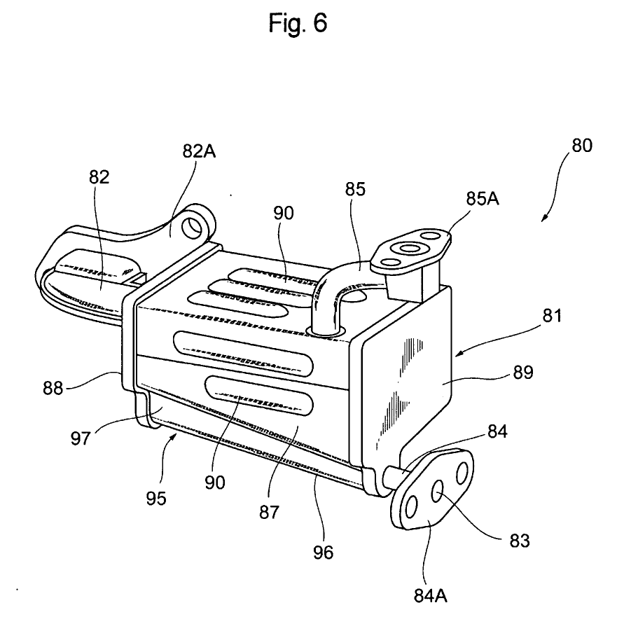

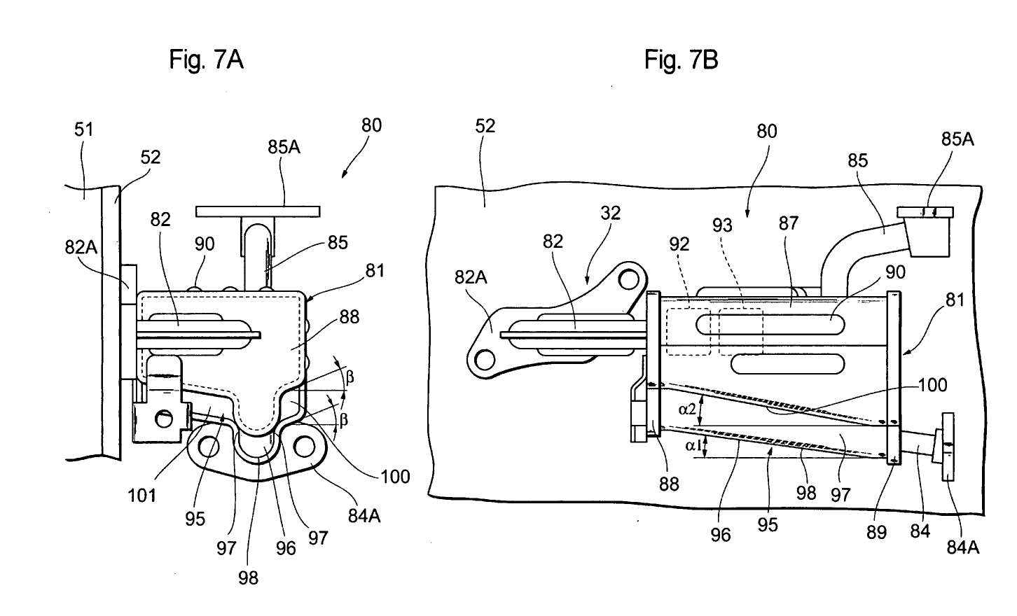

Next, a second embodiment of a fuel cell system according to the present invention will be described primarily with reference to FIG. 6 and FIGS. 7A and 7B mainly regarding the difference between the second embodiment and the first embodiment. It is to be noted that the same signs are provided to the same parts as in the first embodiment.

The second embodiment is different from the first embodiment in the gas-liquid separator. A gas-liquid separator 80 in the second embodiment has: a horizontally long box-shaped case 81; a gas introduction pipe 82 extending from the side surface of the case 81 at one end of its longitudinal direction; a water discharge pipe 84 which horizontally extends from the side surface of the case 81 at the other end of its longitudinal direction so that a water outlet 83 at the tip is horizontally open; and a gas discharge pipe 85 extending from the top surface of the case 81.

The case 81 has a substantially cylindrical body 87, and side plates 88, 89 closing the openings at both sides of the body 87. The body 87 and the side plates 88, 89 are formed by press-molding thin plates. The gas introduction pipe 82 is connected to the side plate 88, the water discharge pipe 84 is connected to the side plate 89, and the gas discharge pipe 85 is connected to the body 87. In addition, a plurality of reinforcing ribs 90 are formed on the body 87.

A flange portion 82A is formed at the tip of the gas introduction pipe 82, and the gas-liquid separator 80 is fixed to an end plate 52 via the flange portion 82A with, for example, bolts. The gas introduction pipe 82 extends from the flange portion 82A perpendicularly to the planar direction of the end plate 52, and then bends along the planar direction of the end plate 52. This bending portion is connected to the upper part of the case 81.

In the case 81, there are provided a filter 92 for removing foreign objects from a hydrogen off-gas introduced via the gas introduction pipe 82, and an ion exchanger 93 for removing metal ions from the hydrogen off-gas passed through the filter 92.

Water drops separated from the hydrogen off-gas in the gas-liquid separator 80 run down the inner surface of the case 81 into a bottom 95 of the case 81. As the body 87 is formed of a thin plate of a uniform thickness, the thickness of the bottom 95 is also uniform. When viewed in the front surface perpendicular to the end plate 52, the bottom 95 is, as a whole, shaped to be forwardly downwardly inclined from the gas introduction pipe 82 to the water discharge pipe 84, that is, to the water outlet 83 at its tip.

In the bottom 95 of the case 81, a downward recess 96 is formed to extend along the inclination direction of the bottom 95. This recess 96 is shaped so that the lower edges of a pair of standing plates 97, 97 respectively projecting downward from the sides close to and far from the end plate 52 are connected by a semi-cylindrical bottom plate 98. The bottom 95 of the case 81 is composed of this recess 96, and side bottoms 100, 101 extending on both sides of the recess 96 from its upper edges.

Here, an inclination angle α1 of the bottom plate 98 of the recess 96 in a front view is set at a first predetermined angle so that the bottom plate 98 is not inversely inclined even when a vehicle equipped therewith is inclined in a normal range. In contrast, an inclination angle α2 of the side bottoms 100, 101 in a front view is set at a second predetermined angle greater than the first predetermined angle. That is, the inclination angle α2 of the side bottoms 100, 101 other than the recess 96 in the bottom 95 may be greater than the inclination angle α1 of the recess 96.

Furthermore, the side bottoms 100, 101 on both sides are also inclined to be lower on the side of the recess 96 in a side view. An angle β of this inclination is also set at the same first predetermined angle as the bottom plate 98 of the recess 96.

Moreover, the water discharge pipe 84 and its water outlet 83 are provided in the extending direction of the recess 96. A flange portion 84A is formed in the water discharge pipe 84 at the position of the water outlet 83, and the water discharge pipe 84 is joined to an air/water discharge valve 36 (see FIG. 1) via the flange portion 84A.

The hydrogen off-gas from which water has been removed in the gas-liquid separator 80 is discharged from its upper gas discharge pipe 85, and a flange portion 85A is formed at the upper end of the gas discharge pipe 85. A circulating pump 38 (see FIG. 1) for returning the water-removed hydrogen off-gas to a fuel cell 10 is joined to the flange portion 85A.

According to the second embodiment of the fuel cell system 1 described above, the gas-liquid separator 80 for separating the gas and liquid in the hydrogen off-gas discharged from fuel cell stacks 51, 51 is fixed to the end plate 52, so that exhaust heat of the fuel cell stacks 51, 51 is transmitted to the gas-liquid separator 80 via the end plate 52 and can be thus effectively used to satisfactorily heat the gas-liquid separator 80. Consequently, water inside the gas-liquid separator 80 can be inhibited from freezing.

Furthermore, the gas-liquid separator 80 is horizontally provided with the water outlet 83. Therefore, even if the height of the gas-liquid separator 80 is limited due to the interference with a traction motor below, the size of the case 81 for retaining water can be assured. Consequently, the interval of the opening operation of the air/water discharge valve 36 can be increased.

Moreover, as the bottom 95 is forwardly downwardly inclined toward the water outlet 83 as a whole, water can be satisfactorily guided to the water outlet 83 owing to the inclination of the bottom 95 even if the water outlet 83 is horizontally provided.

Furthermore, the downward recess 96 is formed in the bottom 95 to extend along the inclination direction of the bottom 95, and the water outlet 83 is provided to extend from the recess 96. Thus, even if the amount of retained water is small, the height of water can be assured by the recess 96, and the amount of the hydrogen off-gas to be discharged from the water outlet 83 can be controlled.

In addition, the inclination angle α2 of the side bottoms 100, 101 other than the recess 96 in the bottom 95 is greater than the inclination angle α1 of the recess 96. This enables the inclination of the whole bottom 95 to be maintained by the side bottoms 100, 101 while the volume of water retained in the recess 96 is being assured even when the vehicle is inclined.

Moreover, as the bottom plate 98 of the recess 96 is semi-cylindrical, the volume of water in the recess 96 can be assured so that workability is maintained at the same time.

1. A fuel cell system comprising:
a fuel cell stack having a plurality of stacked cells which generate electricity by an electrochemical reaction between a fuel gas and an oxidizing gas, and held between a pair of end plates arranged at both ends in the stacking direction of the cells; and
a gas-liquid separator which separates a gas and a liquid of an off-gas discharged from the fuel cell stack,
wherein the gas-liquid separator is fixed to the end plate, and the main component of the gas-liquid separator is formed by press-molding a thin plate.

2. The fuel cell system according to claim 1, wherein
the gas-liquid separator includes a ribbon section which forms the introduced off-gas into a swirl flow to separate liquid drops therefrom, and the ribbon section is disposed adjacently to the end plate.

3. The fuel cell system according to claim 1, wherein
a circulating pump which returns the off-gas to the fuel cell stack is connected to a gas outlet of the gas-liquid separator via a pipe, and
the pipe is provided with a foldback portion which folds back at an angle of more than 90 degrees.

4. The fuel cell system according to claim 1, wherein
the gas-liquid separator is horizontally provided with a water outlet, and a bottom of the gas-liquid separator is forwardly downwardly inclined toward the water outlet.

5. The fuel cell system according to claim 4, wherein
a downward recess is formed in the bottom to extend along the inclination direction of the bottom, and the water outlet is provided to extend from the recess.

6. The fuel cell system according to claim 5, wherein
the inclination angle of side bottoms other than the recess in the bottom is greater than the inclination angle of the recess.
